(19) United States
(12) Patent Application Publication
(10) Pub. No.: US 2019/0210300 A1
(43) Pub. Date: Jul. 11, 2019

(54) Pet toy and manufacturing method thereof

(71) Applicant: Wing Yin CHUNG, Kwun Tong (CN)

(72) Inventor: Wing Yin CHUNG, Kwun Tong (CN)

(21) Appl. No.: 15/865,181

(22) Filed: Jan. 8, 2018

(51) Int. Cl. B29C 67/20; A01K 15/02

(52) U.S. Cl. CPC B29C 67/205; B29K 2105/04; A01K 15/025

(57) ABSTRACT

The present invention relates to a pet toy and manufacturing method thereof. The pet toy comprises a plastic material formed by bonding expanded thermoplastic polyurethane foam beads with an adhesive; wherein each of the expanded thermoplastic polyurethane foam beads is in an irregular spherical shape; each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g. The pet toy has a high tensile strength, a high resilience, a low water absorption rate and a light weight.

### BACKGROUND OF THE INVENTION

The present invention relates to a plastic particle and manufacturing method thereof and more particularly pertains to a pet toy and manufacturing method thereof.

Conventional pet toys for dogs to bite are made of natural or synthetic resin materials. Although pet toys made of natural or synthetic resin materials have sufficient tensile strength for dogs to bite for a long time, they are heavy in weight and are therefore less suitable for small dogs. Besides, for pet toys to be durable and capable of withstanding prolonged biting by dogs, such pet toys have a high hardness and could easily injure the dogs' teeth if the dogs bite hard on the pet toys.

### BRIEF SUMMARY OF THE INVENTION

In view of the aforesaid disadvantages now present in the prior art, the present invention provides a pet toy and manufacturing method thereof wherein the pet toy has a high tensile strength, a high resilience, a low water absorption rate and a light weight.

To attain this, the pet toy of the present invention comprises a plastic material formed by bonding expanded thermoplastic polyurethane foam beads with an adhesive; wherein each of the expanded thermoplastic polyurethane foam beads is in an irregular spherical shape; each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g/L.

Preferably, each of the expanded thermoplastic polyurethane foam beads is in spherical or ellipsoid shape.

Preferably, the adhesive comprises 46-50 weight percentage of methylenedi-p-phenylene diisocyanate and 50-54 weight percentage of 1-isocyanato-2-[(4-isocyanatophenyl)methyl]-benzene.

Preferably, ratio of the expanded thermoplastic polyurethane foam beads to the adhesive is 0.7-0.8:0.2-0.3.

Preferably, the pet toy has a tensile strength of 1400 KPa, a resilience of 60% and a water absorption rate of less than 2%

The manufacturing process of the pet toy of the present invention comprises the following steps:

a. Preparing a plastic material by bonding expanded thermoplastic polyurethane foam beads with an adhesive; wherein each of the expanded thermoplastic polyurethane foam beads is in an irregular spherical shape; each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g;

b. Preparing the pet toy by molding the plastic material in a mold at a temperature of 50-120° C. for 5-10 minutes.

Preferably, molding is performed at a temperature of 100-120° C. for 5-6 minutes.

The pet toy of the present invention has a tensile strength of 1400 KPa which is higher than that of existing pet toys made of natural or synthetic resin materials. As the tensile strength is high, it is possible to manufacture the pet toy which is durable and robust enough to withstand prolonged biting by dogs with the least possible material. As the water absorption rate is low, dog saliva could hardly be absorbed and thus the pet toy is easier to clean. The high resilience of the pet toy reduces the risks that the dogs' teeth are injured as the dogs bite too hard on the pet toy. The pet toy is also lighter in weight so that it is suitable for use by small dogs as well.

### DETAILED DESCRIPTION OF THE INVENTION

### Embodiment 1

In Embodiment 1, the pet toy is manufactured by the following steps:

a. Preparing a plastic material by bonding expanded thermoplastic polyurethane foam beads with an adhesive; wherein each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g/L; the ratio of the expanded thermoplastic polyurethane foam beads to the adhesive is 0.7:0.3; the adhesive comprises 50 weight percentage of methylenedi-p-phenylene diisocyanate and 50 weight percentage of 1-isocyanato-2-[(4-isocyanatophenyl)methyl]-benzene.

b. Preparing the pet toy by molding the plastic material in a mold at a temperature of 50° C. for 10 minutes.

### Embodiment 2

In Embodiment 2, the pet toy is manufactured by the following steps:

a. Preparing a plastic material by bonding expanded thermoplastic polyurethane foam beads with an adhesive; wherein each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g/L; the ratio of the expanded thermoplastic polyurethane foam beads to the adhesive is 0.8:0.2; the adhesive comprises 46 weight percentage of methylenedi-p-phenylene diisocyanate and 54 weight percentage of 1-isocyanato-2-[(4-isocyanatophenyl)methyl]-benzene.

b. Preparing the pet toy by molding the plastic material in a mold at a temperature of 120° C. for 5 minutes.

### Embodiment 3

In Embodiment 3, the pet toy is manufactured by the following steps:

a. Preparing a plastic material by bonding expanded thermoplastic polyurethane foam beads with an adhesive; wherein each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g/L; the adhesive is in form of diphenylmethane diisocyanate; the ratio of the expanded thermoplastic polyurethane foam beads to the adhesive is 0.75:0.25; the adhesive comprises 48 weight percentage of methylenedi-p-phenylene diisocyanate and 52 weight percentage of 1-isocyanato-2-[(4-isocyanatophenyl)methyl]-benzene.

b. Preparing the pet toy by molding the plastic material in a mold at a temperature of 100° C. for 6 minutes.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A plastic article comprising a plastic material formed by bonding expanded thermoplastic polyurethane foam beads with an adhesive; wherein each of the expanded thermoplastic polyurethane foam beads is in an irregular spherical shape; each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g; the plastic article is a pet toy.

2. The plastic article as in claim 1, wherein each of the expanded thermoplastic polyurethane foam beads is in spherical or ellipsoid shape.

3. The plastic article as in claim 1, wherein the adhesive comprises 46-50 weight percentage of methylenedi-p-phenylene diisocyanate and 50-54 weight percentage of 1-isocyanato-2-[(4-isocyanatophenyl)methyl]-benzene.

4. The plastic article as in claim 1, wherein ratio of the expanded thermoplastic polyurethane foam beads to the adhesive is 0.7-0.8:0.2-0.3.

5. The plastic article as in claim 1, wherein the plastic article has a tensile strength of 1400 KPa, a resilience of 60% and a water absorption rate of less than 2%.

6. A manufacturing process of the plastic article as in claim 1 comprising the following steps:
a. Preparing a plastic material by bonding expanded thermoplastic polyurethane foam beads with an adhesive; wherein each of the expanded thermoplastic polyurethane foam beads is in an irregular spherical shape; each of the expanded thermoplastic polyurethane foam beads has a length of 3-6 mm in each of x, y, z directions; each of the expanded thermoplastic polyurethane foam beads has a weight of 20-30 mg; the expanded thermoplastic polyurethane foam beads have a bulk density of 100-150 g/L;
b. Preparing the plastic article by molding the plastic material in a mold at a temperature of 50-120° C. for 5-10 minutes;
wherein the plastic article is a pet toy.

7. The manufacturing process as in claim 6, wherein molding is performed at a temperature of 100-120° C. for 5-6 minutes.
